(19) United States
(12) Patent Application Publication
(10) Pub. No.: US 2026/0184061 A1
(43) Pub. Date: Jul. 2, 2026

(54) PEELING MECHANISM AND PEELING METHOD

(71) Applicant: HONDA MOTOR CO., LTD., Tokyo (JP)

(72) Inventors: Satoshi AOKI, Saitama (JP); Hirotaka SANO, Saitama (JP); Yayoi MATSUSHITA, Saitama (JP); Tsugio MASUDA, Saitama (JP)

(73) Assignee: HONDA MOTOR CO., LTD., Tokyo (JP)

(21) Appl. No.: 19/412,888

(22) Filed: Dec. 9, 2025

(30) Foreign Application Priority Data
Dec. 26, 2024 (JP) 2024-229774

(51) Int. Cl. B32B 43/00; H01M 10/04; B32B 37/00

(52) U.S. Cl. CPC B32B 43/006; H01M 10/0404; B32B 37/025; B32B 2457/10

(57) ABSTRACT

A peeling mechanism is configured to peel a base material from a transfer body transferred to a substrate sheet. The peeling mechanism has a peeling roller which peels the base material from the transfer body, and a base material roll body which winds the base material peeled by the peeling roller. The peeling roller peels the base material in a direction opposite to a conveyance direction of the substrate sheet.

### CROSS-REFERENCE TO RELATED APPLICATIONS

This application is based on and claims priority under 35 USC 119 from Japanese Patent Application No. 2024-229774 filed on December 26, 2024, the entire content of which is incorporated herein by reference.

### TECHNICAL FIELD

The present disclosure relates to a peeling mechanism and a peeling method.

### BACKGROUND ART

In recent years, researches and developments have been conducted on a secondary battery which contributes to improvement in energy efficiency in order to allow more people to have access to affordable, reliable, sustainable and advanced energy.

In related art, as a method for producing a solid-state battery, there is known a production method of pressing a positive electrode layer, a solid electrolyte layer, and a negative electrode layer with a roll (for example, JP2023-085663A).

In transfer of the solid electrolyte layer to the positive electrode layer, a base material is peeled from the solid electrolyte layer after the solid electrolyte layer provided on the base material is transferred to the positive electrode layer by roll pressing, and accuracy in peeling the base material may decrease.

### SUMMARY OF INVENTION

The present disclosure provides a peeling mechanism and a peeling method that enable to improve accuracy in peeling a base material from a solid electrolyte layer. This further contributes to improvement in energy efficiency.

A first aspect of the present disclosure is to a peeling mechanism configured to peel a base material from a transfer body transferred to a substrate sheet, the peeling mechanism including:

a peeling roller configured to peel the base material from the transfer body; and

a base material roll body configured to wind the base material peeled by the peeling roller, in which

the peeling roller peels the base material in a direction opposite to a conveyance direction of the substrate sheet.

A second aspect of the present disclosure is to a peeling method of peeling a base material from a transfer body transferred to a substrate sheet, the peeling method including:

recognizing a peeling start point at which the base material is peeled;

controlling the peeling start point to be placed at a predetermined position; and

peeling the base material in a direction opposite to a conveyance direction of the substrate sheet, based on the peeling start point controlled to the predetermined position.

According to the aspects of the present disclosure, it is possible to improve accuracy in peeling the base material sheet from the solid electrolyte layer. This can further contribute to improvement in energy efficiency.

### BRIEF DESCRIPTION OF DRAWINGS

Exemplary embodiment(s) of the present invention will be described in detail based on the following figures, wherein:

FIG. 1 is a cross-sectional view showing an example of a solid-state battery 1;

FIG. 2 shows an example of a press device 100 for producing the solid-state battery 1;

FIG. 3 shows a part of the press device 100, and particularly, shows an example of a configuration where a base material sheet 123 is peeled after a first solid electrolyte layer SE1 is transferred;

FIG. 4 shows an example of a peeling mechanism 132;

FIG. 5 shows a part of the press device 100, and particularly, shows an example of transfer by an intermediate layer transfer roller 150 and a negative electrode transfer roller 160;

FIG. 6 is a flowchart showing an example of a press method of the press device 100 including a peeling method; and

FIG. 7 shows another example of the peeling mechanism 132;

FIG. 8 shows a comparative example of a peeling mechanism 132a.

### DESCRIPTION OF EMBODIMENTS

Hereinafter, an embodiment will be described with reference to the accompanying drawings. A peeling mechanism 132 in the embodiment is a part of a press device 100 that produces a solid-state battery 1. A peeling method is a part of a press method using the press device 100. In the following description, the solid-state battery 1, the press device 100 including the peeling mechanism 132, and the press method including the peeling method will be described in this order.

### Solid-State Battery

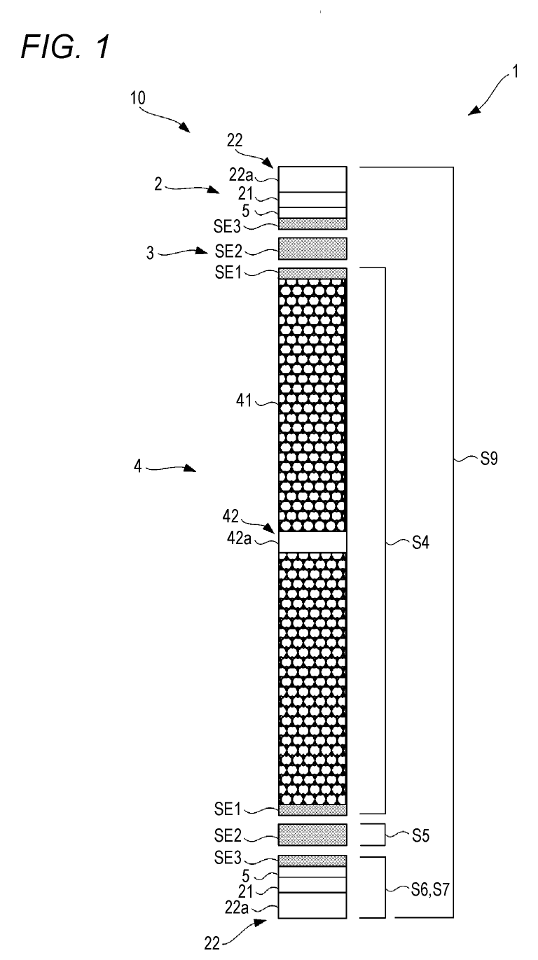

FIG. 1 is a schematic diagram showing an example of the solid-state battery 1. The solid-state battery 1 is an all-solid-state battery including an electrode 10 in which a negative electrode layer 2, a solid electrolyte layer 3, and a positive electrode layer 4 are laminated. In the embodiment, as shown in FIG. 1, a structure in which the negative electrode layer 2, the solid electrolyte layer 3, the positive electrode layer 4, the solid electrolyte layer 3, and the negative electrode layer 2 are laminated in this order will be described as a laminated structure of the solid-state battery 1. The structure of the solid-state battery 1 is not limited to the above. The solid-state battery 1 may have, for example, a configuration that can be used for a solid-state battery such as an exterior body in addition to the electrode 10 shown in FIG. 1.

The solid electrolyte layer 3 in the solid-state battery 1 includes at least a first solid electrolyte layer SE1 disposed on a side of the positive electrode layer 4 and a negative electrode side solid electrolyte layer SE3 disposed on a side of the negative electrode layer 2. The solid electrolyte layer 3 may include a second solid electrolyte layer SE2 disposed adjacent to the first solid electrolyte layer SE1. In the embodiment, the solid electrolyte layer 3 is described as including the three layers described above. An intermediate layer 5 may be disposed as desired between the negative electrode layer 2 and the solid electrolyte layer 3.

The solid-state battery 1 is not particularly limited, and may be a lithium ion solid-state secondary battery or a lithium metal secondary battery.

### Negative Electrode Layer

The negative electrode layer 2 includes a negative electrode active material layer 21 and a negative electrode current collector layer 22. The negative electrode active material layer 21 is not particularly limited and may be made of a material that can be used as a negative electrode active material of the solid-state battery 1. Examples of the negative electrode active material constituting the negative electrode active material layer 21 include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metal indium.

In addition to the above, the negative electrode active material layer 21 may contain a material that can be contained in the negative electrode active material layer 21 of the solid-state battery 1. Examples of the material include a solid electrolyte, a conductive assistance, and a binder. Examples of the solid electrolyte include the same solid electrolytes as those contained in the solid electrolyte layer 3 to be described later. Examples of the conductive assistance include carbon black, natural graphite, carbon fiber, and carbon nanotube. Examples of the binder include nitrile polymers, polyester polymers, acrylic acid polymers, cellulose polymers, styrene polymers, styrene butadiene polymers, vinyl acetate polymers, urethane polymers, and fluoroethylene polymers.

The negative electrode current collector layer 22 is not particularly limited and may be made of copper, nickel, stainless steel, or the like. Examples of a shape of the negative electrode current collector layer 22 include a foil shape, a plate shape, a mesh shape, a nonwoven fabric shape, and a foam shape. In the embodiment, the negative electrode current collector layer 22 is formed of a negative electrode current collecting foil 22a.

### Solid Electrolyte Layer

The solid electrolyte layer 3 is formed between the negative electrode layer 2 and the positive electrode layer 4. In the embodiment, the solid electrolyte layer 3 has a structure in which the first solid electrolyte layer SE1 disposed in contact with the positive electrode layer, the second solid electrolyte layer SE2, and the negative electrode side solid electrolyte layer SE3 disposed on the side of the negative electrode layer 2 are laminated in this order.

The first solid electrolyte layer SE1 is disposed in contact with a positive electrode active material layer 41 in the positive electrode layer 4. A solid electrolyte constituting the first solid electrolyte layer SE1 is not particularly limited and may be a material that can be used as an electrolyte for a solid-state battery. Examples thereof include inorganic solid electrolytes such as sulfide solid electrolytes, oxide solid electrolytes, halide solid electrolytes, and lithium-containing salts, and polymer-based solid electrolytes such as polyethylene oxide. The above-described solid electrolytes may be used alone or two or more thereof may be used in combination.

The first solid electrolyte layer SE1 contains a binder in addition to the solid electrolyte material. As the binder, the same material as the binder that can be contained in the negative electrode active material layer 21 can be used. A content of the binder with respect to mass of the entire first solid electrolyte layer SE1 in the first solid electrolyte layer SE1 is equal to or greater than a content of the binder with respect to mass of the entire second solid electrolyte layer SE2 in the second solid electrolyte layer SE2. An upper limit of the content of the binder in the first solid electrolyte layer SE1 is, for example, 25 mass%. The content of the binder in the first solid electrolyte layer SE1 is preferably 10 mass% to 30 mass%. Accordingly, it is easier for the first solid electrolyte layer SE1 to extend following the positive electrode layer 4 when the positive electrode layer 4 is pressed (stamped).

In addition to the solid electrolyte material and the binder, the first solid electrolyte layer SE1 may contain a material that can be used for a solid electrolyte layer of a solid-state battery.

A thickness of the first solid electrolyte layer SE1 (a length of each layer in a lamination direction) is preferably less than a thickness of the second solid electrolyte layer SE2. The thickness of the first solid electrolyte layer SE1 is preferably, for example, 3 μm to 15 μm.

The second solid electrolyte layer SE2 is a layer disposed as desired and is disposed adjacent to the first solid electrolyte layer SE1. A solid electrolyte material constituting the second solid electrolyte layer SE2 is not particularly limited and may be the same material as the solid electrolyte material constituting the first solid electrolyte layer SE1. Similarly to the first solid electrolyte layer SE1, the second solid electrolyte layer SE2 may contain a binder or the like in addition to the solid electrolyte material. A content of the binder in the second solid electrolyte layer SE2 is equal to or less than the content of the binder in the first solid electrolyte layer SE1. The content of the binder in the second solid electrolyte layer SE2 is preferably, for example, 10 mass% to 30 mass%. Accordingly, energy density of the solid-state battery 1 can be improved. The second solid electrolyte layer SE2 may include a support. The support may be a three-dimensional structure such as a mesh, a woven fabric, a nonwoven fabric, an embossed body, a punched body, an expanded body, or foam. The second solid electrolyte layer SE2 may not contain the support.

The thickness of the second solid electrolyte layer SE2 (the length of each layer in the lamination direction) is preferably greater than the thickness of the first solid electrolyte layer SE1. In addition, the thickness of the second solid electrolyte layer SE2 is preferably greater than a thickness of the negative electrode side solid electrolyte layer SE3 to be described later. The thickness of the second solid electrolyte layer SE2 is preferably, for example, 10 μm to 50 μm.

The negative electrode side solid electrolyte layer SE3 is disposed on the side of the negative electrode layer 2. The negative electrode side solid electrolyte layer SE3 is disposed adjacent to the negative electrode layer 2. When the solid-state battery 1 includes the intermediate layer 5 as shown in FIG. 1, the negative electrode side solid electrolyte layer SE3 may be disposed adjacent to the intermediate layer 5.

A solid electrolyte material constituting the negative electrode side solid electrolyte layer SE3 is not particularly limited and may be the same material as the solid electrolyte material constituting the first solid electrolyte layer SE1. A content of the binder in the negative electrode side solid electrolyte layer SE3 is preferably, for example, 1.3 mass% to 8.7 mass%. In terms of vol%, the content of the binder in the negative electrode side solid electrolyte layer SE3 is preferably, for example, 2.7 vol% to 10 vol%. The content of the binder in the negative electrode side solid electrolyte layer SE3 is less than the content of the binder in the first solid electrolyte layer SE1.

The thickness of the negative electrode side solid electrolyte layer SE3 (the length of each layer in the lamination direction) is preferably less than the thickness of the second solid electrolyte layer SE2. The thickness of the negative electrode side solid electrolyte layer SE3 is preferably, for example, 3 μm to 8.5 μm.

### Positive Electrode Layer

The positive electrode layer 4 includes the positive electrode active material layer 41 and a positive electrode current collector layer 42. In the embodiment, the positive electrode layer 4 has a configuration in which two positive electrode active material layers 41 are laminated on two surfaces of one positive electrode current collector layer 42. The configuration of the positive electrode layer 4 is not limited to the above, and a configuration may be adopted in which one positive electrode active material layer 41 is laminated on one surface of one positive electrode current collector layer 42.

The positive electrode active material layer 41 is not particularly limited and may be made of a material that can be used as a positive electrode active material of a solid-state battery. Examples of the positive electrode active material constituting the positive electrode active material layer 41 include layered positive electrode active material particles such as LiCoO₂, LiNiO₂, LiCoₓNi_{y}Mn_{z}O₂ (x + y + z = 1), LiVO₂, and LiCrO₂, spinel-type positive electrode active materials such as LiMn₂O₄, Li(Ni_{0.25}Mn_{0.75})₂O₄, LiCoMnO₄, and Li₂NiMn₃O₈, olivine-type positive electrode active materials such as LiCoPO₄, LiMnPO₄, and LiFePO₄, solid solution oxides (Li₂MnO₃-LiMO₂ (M = Co, Ni, or the like), conductive polymers such as polyaniline and polypyrrole, sulfides such as Li₂S, CuS, Li-Cu-S compounds, TiS₂, FeS, MoS₂, and Li-Mo-S compounds, and mixtures of sulfur and carbon. The positive electrode active material may contain one of the above materials or may contain two or more of the above materials.

The positive electrode active material layer 41 may include a binder or the like. A content of the binder in the positive electrode active material layer 41 is preferably 0.5 mass% to 5 mass%. Preferably, the content may be 2.56 mass%. A thickness of the positive electrode active material layer 41 (the length of each layer in the lamination direction) is preferably, for example, 80 μm to 100 μm. Accordingly, a battery capacity of the solid-state battery 1 can be improved.

The positive electrode current collector layer 42 is not particularly limited and may be made of, for example, aluminum, stainless steel, or conductive carbon (for example, graphite or carbon nanotube). Examples of a shape of the positive electrode current collector layer 42 include a foil shape, a plate shape, a mesh shape, a nonwoven fabric shape, and a foam shape. In the embodiment, the positive electrode current collector layer 42 is formed of a positive electrode current collecting foil 42a.

### Intermediate Layer

The intermediate layer 5 is disposed between the negative electrode layer 2 and the solid electrolyte layer 3. For example, when the solid-state battery 1 is a lithium metal battery, the intermediate layer 5 has a function of uniformly depositing lithium metal. Therefore, an interface between the intermediate layer 5 and the solid electrolyte layer 3 is stabilized. When the solid-state battery 1 is a lithium metal secondary battery having the intermediate layer 5, the solid-state battery 1 may be an anode-free battery where the negative electrode active material layer 21 is not present at the time of initial charge. In this case, a lithium metal layer as the negative electrode active material layer 21 is formed after initial charge and discharge.

A material constituting the intermediate layer 5 is not particularly limited, and examples thereof include amorphous carbon and a metal that can alloy with lithium. Examples of the metal that can alloy with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). The metal that can alloy with lithium may be nanoparticles. Examples of the amorphous carbon include carbon blacks such as acetylene black, furnace black, and Ketjen black, coke, and activated carbon. The amorphous carbon may be graphitizable carbon (soft carbon), non-graphitizable carbon (hard carbon), carbon nanotube (CNT), fullerene, or graphene. The intermediate layer may contain a binder in addition to the above materials.

### Press Device

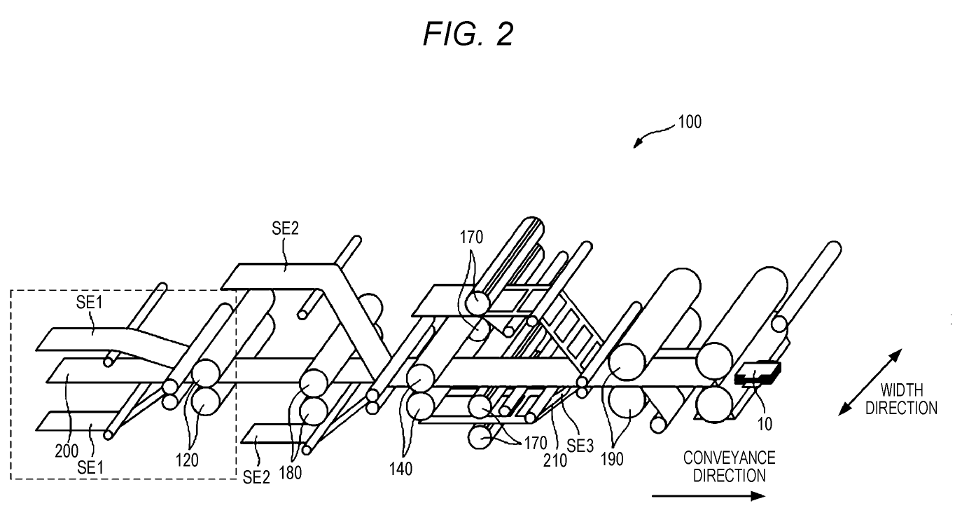

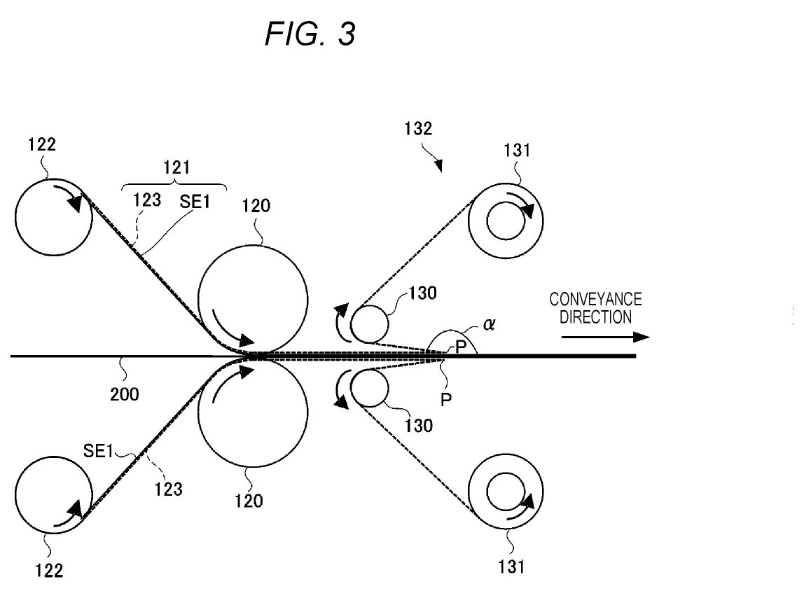

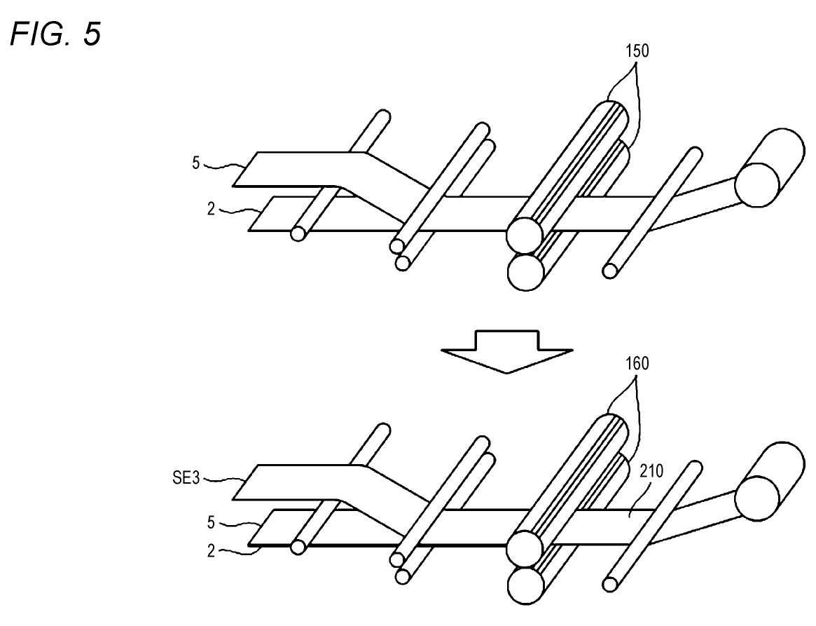

Next, a configuration of the press device 100 for producing the solid-state battery 1 configured as described above will be described. FIG. 2 shows an example of the press device 100 in the embodiment. The press device 100 includes, as main components, a first positive electrode transfer roller 120, a peeling roller 130 (see FIG. 3), a second positive electrode transfer roller 140, an intermediate layer transfer roller 150 (see FIG. 5), a negative electrode transfer roller 160 (see FIG. 5), a negative electrode sheet member lamination roller 170, a positive electrode press roll 180, and an integration press roll 190. The peeling roller 130 is a part of a component of the peeling mechanism 132 to be described later. The press device 100 continuously produces the solid-state battery 1 while feeding a positive electrode sheet member 200 in one direction by each of these rollers.

In FIG. 2, a direction in which the positive electrode sheet member 200 is fed is defined as a "conveyance direction", and a direction orthogonal to the conveyance direction is defined as a "width direction". In addition, FIG. 1 shows a range to be stamped or pressed to transfer in a positive electrode press step S4, a second solid electrolyte layer transfer step S5, an intermediate layer transfer step S6, a negative electrode side solid electrolyte layer transfer step S7, and an integration press step S9 to be described later.

The positive electrode sheet member 200 is an example of a "substrate sheet", and is a sheet-like member obtained by laminating the positive electrode active material layer 41 on the positive electrode current collecting foil 42a constituting the positive electrode current collector layer 42. The positive electrode sheet member 200 is fed by a roller (not shown) and conveyed to continuously extend from a base end side to a terminal end in a production line of the solid-state battery 1.

The first positive electrode transfer roller 120, the peeling roller 130, the second positive electrode transfer roller 140, the intermediate layer transfer roller 150, the negative electrode transfer roller 160, and the negative electrode sheet member lamination roller 170 each include a pair of rotating bodies having a predetermined length in the width direction.

These rotating bodies are arranged in an order of the first positive electrode transfer roller 120, the peeling roller 130, the positive electrode press roll 180, the second positive electrode transfer roller 140, the negative electrode sheet member lamination roller 170, and the integration press roll 190 from an upstream side along the conveyance direction of the positive electrode sheet member 200.

The intermediate layer transfer roller 150 and the negative electrode transfer roller 160 are disposed away from a conveyance line along which the positive electrode sheet member 200 is conveyed in the conveyance direction (hereinafter, simply referred to as the "conveyance line"), and perform transfer pressing for the intermediate layer 5 or the negative electrode side solid electrolyte layer SE3. Thereafter, as will be described later, the negative electrode layer 2 and the intermediate layer 5 to which the negative electrode side solid electrolyte layer SE3 is transferred are conveyed to an upper surface side or a lower surface side of the positive electrode sheet member 200, join the conveyance line of the positive electrode sheet member 200, and are laminated by the negative electrode sheet member lamination roller 170.

The first positive electrode transfer roller 120, the second positive electrode transfer roller 140, the intermediate layer transfer roller 150, and the negative electrode transfer roller 160 perform transfer pressing by passing a sheet such as a base material on a transfer receiving side and a sheet provided with a solid electrolyte layer to be transferred while sandwiching the sheets between a pair of rollers and pressing.

FIG. 3 is an enlarged view showing a portion surrounded by a broken line in FIG. 2 in more detail. As shown here, the first positive electrode transfer roller 120 sandwiches and presses, between a pair of rollers, a transfer sheet 121 unwound from a transfer sheet roll body 122 around which the transfer sheet 121 is wound. Accordingly, the first solid electrolyte layer SE1 provided on the transfer sheet 121 can be transferred to the positive electrode sheet member 200. The first solid electrolyte layer SE1 is an example of a "transfer body".

As shown in FIG. 3, the transfer sheet 121 includes the first solid electrolyte layer SE1 and a base material sheet 123 provided with the first solid electrolyte layer SE1. The base material sheet 123 is peeled from the transferred first solid electrolyte layer SE1 by the peeling mechanism 132, and is made of, for example, polyethylene terephthalate (PET).

Here, the peeling mechanism 132 in the embodiment will be described. The peeling mechanism 132 includes the above-described peeling roller 130 that peels the base material sheet 123 from the first solid electrolyte layer SE1 transferred to the positive electrode sheet member 200, and a base material roll body 131 that winds the base material sheet 123 peeled by the peeling roller 130. As shown in FIG. 3, the peeling mechanism 132 is provided downstream of the first positive electrode transfer roller 120, and peels the base material sheet 123 from the transferred first solid electrolyte layer SE1. In FIG. 3, in the transfer sheet 121 unwound from the transfer sheet roll body 122, the first solid electrolyte layer SE1 is indicated by a solid line, and the peeled base material sheet 123 is indicated by a broken line. Arrows shown in rollers and roll bodies in FIG. 3 indicate rotation directions of the rollers and the roll bodies.

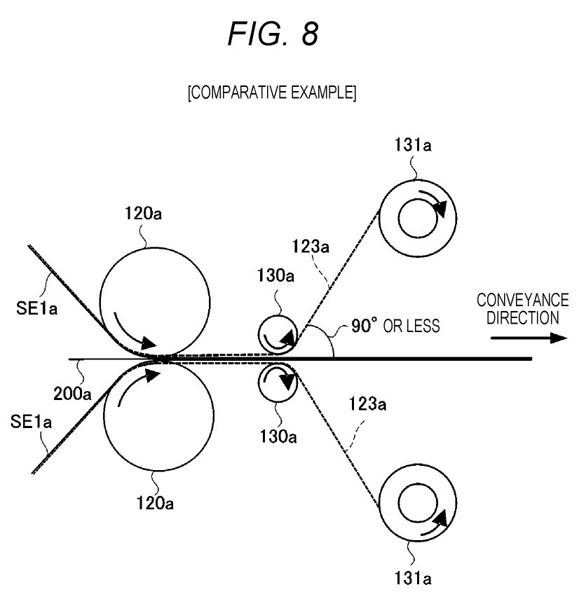

As described above, the base material sheet 123 is peeled, by the peeling roller 130, from the first solid electrolyte layer SE1 transferred to the positive electrode sheet member 200, and peelability of the base material sheet 123 may vary depending on a direction in which the base material sheet 123 is peeled (hereinafter, referred to as the "peeling direction"). For example, as shown in a comparative example in FIG. 8, when a peeling direction of a base material sheet 123a is a direction of 90° or less with a conveyance direction of a positive electrode sheet member 200a to which a first solid electrolyte layer SE1a is transferred being 0°, the base material sheet 123a is pulled up by the peeling roller 130 in the direction of 90° or less. In such a case, the peeling direction of the base material sheet 123a and the conveyance direction of the positive electrode sheet member 200a become the same direction, an appropriate shear force cannot be generated between a first solid electrolyte layer SE1a and the base material sheet 123a, and thus peelability of the base material sheet 123a may decrease. For example, the positive electrode sheet member 200a may be bent, or the positive electrode sheet member 200a may be broken from such a bend as a start point. Therefore, in the embodiment shown in FIG. 3, an appropriate shear force is generated between the first solid electrolyte layer SE1 and the base material sheet 123 to improve the peelability of the base material sheet 123. The phrase "the peeling direction and the conveyance direction are the same" means that the base material sheet 123 is peeled at an angle in a range of 0° to 90°. In addition, in the comparative example in FIG. 8, in order to distinguish from the same component in the embodiment, a reference numeral with "a" added after a number is assigned.

In the embodiment, the peeling roller 130 is configured to peel the base material sheet 123 in a direction opposite to the conveyance direction of the positive electrode sheet member 200. Here, "peeling in the direction opposite to the conveyance direction" means that the base material sheet 123 is peeled at an angle of more than 90° and less than 180° when the conveyance direction is 0°. As an example for obtaining such a configuration, the peeling roller 130 is disposed upstream in the conveyance direction of the positive electrode sheet member 200, with respect to a peeling start point P which is a start point at which the base material sheet 123 is peeled from the transferred first solid electrolyte layer SE1. By disposing the peeling roller 130 upstream of the peeling start point P, the base material sheet 123 is peeled from the peeling start point P as the start point in the direction opposite to the conveyance direction, in other words, the base material sheet 123 is pulled in a direction against the conveyance direction. Accordingly, the peelability of the base material sheet 123 can be improved as compared to a case where the conveyance direction and the peeling direction are the same as in the comparative example in FIG. 8 described above, for example.

In the embodiment, as described above, a peeling angle α of the base material sheet 123 is an angle greater than 90° and less than 180° when the conveyance direction is 0°, and in order to improve the peelability of the base material sheet 123, the base material sheet 123 is preferably peeled at a peeling angle closer to an angle parallel to the direction opposite to the conveyance direction. Therefore, the peeling angle α of the base material sheet 123 is more preferably an angle close to 180°.

In this way, by peeling the base material sheet 123 in the direction opposite to the conveyance direction of the positive electrode sheet member 200, the base material sheet 123 is pulled in the direction against the conveyance direction, thus it is possible to generate an appropriate shear force between the first solid electrolyte layer SE1 and the base material sheet 123 and it is possible to prevent occurrence of bending of the positive electrode sheet member 200 or occurrence of breakage starting from such a bend as a start point. As a result, it is possible to improve the peelability when the base material sheet 123 is peeled from the first solid electrolyte layer SE1.

Meanwhile, as described above, since the positive electrode sheet member 200 moves in the conveyance direction at a predetermined speed, when a speed of winding the base material sheet 123 by the base material roll body 131 does not match a speed of conveying the positive electrode sheet member 200, the peeling start point P may be displaced from a predetermined position. In addition, when the speed of winding the base material sheet 123 and the speed of conveying the positive electrode sheet member 200 match each other, the peeling start point P is not supposed to be displaced from the predetermined position theoretically, but in reality, even when the speed of winding the base material sheet 123 and the speed of conveying the positive electrode sheet member 200 match each other, the peeling start point P may be displaced from the predetermined position. Here, the "predetermined position" is an ideal position for the peeling start point P, and is set to, for example, a position where the base material sheet 123 can be stably peeled. In the embodiment, in order to stably peel the base material sheet 123, the peeling start point P is constantly recognized, and the recognized peeling start point P is controlled to the predetermined position.

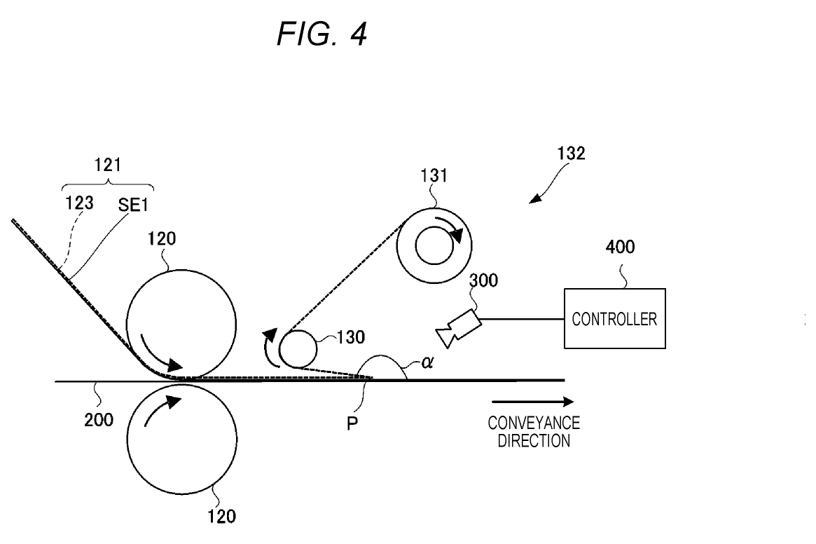

Specifically, as shown in FIG. 4, the peeling mechanism 132 further includes a recognizer 300 that recognizes the peeling start point P and a controller 400 that controls the peeling start point P recognized by the recognizer 300 to the predetermined position. The recognizer 300 may be a camera or the like that can recognize the peeling start point P. Information recognized by the recognizer 300 is output to the controller 400. The controller 400 may be, for example, a known computer including a controller that performs various calculations, a storage unit including a storage medium, and an input and output interface (not shown) that controls input and output of data with respect to the inside and the outside of the controller 400. In the example shown in FIG. 4, configurations of the peeling mechanism 132 and the transfer sheet 121 are shown only above the positive electrode sheet member 200, and lower configurations are omitted.

The controller 400 controls the position of the peeling start point P to the predetermined position by controlling a rotation speed of the base material roll body 131. More specifically, for example, when the peeling start point P is placed downstream of the predetermined position, the controller 400 increases the rotation speed of the base material roll body 131. In other words, when the peeling start point P is placed downstream of the predetermined position, the rotation speed of the base material roll body 131 is relatively lower than the speed of conveying the positive electrode sheet member 200, and thus the controller 400 controls the peeling start point P to the predetermined position by increasing the rotation speed of the base material roll body 131. Conversely, when the peeling start point P is placed upstream of the predetermined position, the rotation speed of the base material roll body 131 is reduced. In other words, when the peeling start point P is placed upstream of the predetermined position, the rotation speed of the base material roll body 131 is relatively higher than the speed of conveying the positive electrode sheet member 200, and thus the controller 400 controls the peeling start point P to the predetermined position by reducing the rotation speed of the base material roll body 131.

In the width direction of the positive electrode sheet member 200, it is still preferable to control the peeling start point P that is a start point at which the base material sheet 123 is peeled from the first solid electrolyte layer SE1. For example, the peeling roller 130 is preferably configured in advance such that one side in the width direction is inclined with respect to the other side. Accordingly, it can be assumed that the base material sheet 123 peeled from the first solid electrolyte layer SE1 is peeled while being inclined from the one side to the other side in the width direction. In such a case, a peeling start point line connecting the peeling start points P in the width direction is configured to be inclined with respect to the width direction.

Accordingly, since the peeling start point line can be controlled in addition to the position of the peeling start point P, accuracy in peeling the base material sheet 123 can be improved as compared to a case where the peeling roller 130 is not inclined with respect to the width direction.

As shown in FIG. 3, the transfer sheet 121 is provided on two surface sides with the positive electrode sheet member 200 interposed therebetween so as to be vertically symmetric, and is configured to transfer the first solid electrolyte layer SE1 to both surfaces of the positive electrode sheet member 200. Accordingly, the first solid electrolyte layer SE1 can be simultaneously transferred to both surfaces of the positive electrode sheet member 200.

As shown in FIG. 2, the second positive electrode transfer roller 140 transfers the second solid electrolyte layer SE2 onto the positive electrode sheet member 200 to which the first solid electrolyte layer SE1 is transferred and pressed (stamped).

As shown in FIG. 5, the intermediate layer transfer roller 150 transfers the intermediate layer 5 to the negative electrode active material layer 21 laminated on the negative electrode current collecting foil 22a. Accordingly, the intermediate layer 5 is disposed between the negative electrode active material layer 21 and the negative electrode side solid electrolyte layer SE3.

As shown in FIG. 5, the negative electrode transfer roller 160 forms a negative electrode sheet member 210 by transferring the negative electrode side solid electrolyte layer SE3 onto the intermediate layer 5.

As shown in FIG. 2, the negative electrode sheet member lamination roller 170 conveys and laminates the negative electrode sheet member 210, to which the negative electrode side solid electrolyte layer SE3 is transferred, onto the positive electrode sheet member 200 to which the first solid electrolyte layer SE1 and the second solid electrolyte layer SE2 are transferred.

As shown in FIG. 2, each of the positive electrode press roll 180 and the integration press roll 190 is constituted by a pair of rotating rollers similarly to each transfer roller, and the positive electrode sheet member 200 where the solid electrolyte layers and the like are laminated according to each process is interposed between the pair of rollers, passed therethrough while being pressed, and thus densified. The positive electrode press roll 180 presses (stamps) the positive electrode sheet member 200 to which the first solid electrolyte layer SE1 is transferred. The integration press roll 190 presses (stamps) the positive electrode sheet member 200 and the negative electrode sheet member 210 in a laminated state to integrate the electrode 10. Accordingly, the positive electrode sheet member 200 and the negative electrode sheet member 210 are integrated, and at the same time, the first solid electrolyte layer SE1, the second solid electrolyte layer SE2, and the negative electrode side solid electrolyte layer SE3 are densified.

### Press Method

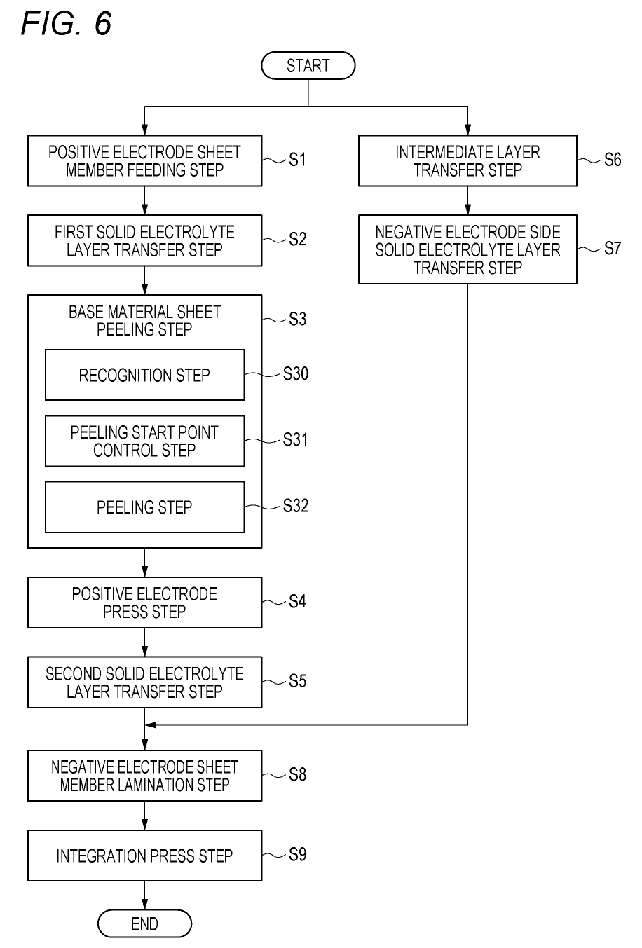

Next, a press method using the press device 100 for the solid-state battery 1 configured as described above will be described. FIG. 6 is a flowchart showing an example of the press method. The press method includes, as processes, a positive electrode sheet member feeding step S1, a first solid electrolyte layer transfer step S2, a base material sheet peeling step S3, a positive electrode press step S4, a second solid electrolyte layer transfer step S5, an intermediate layer transfer step S6, a negative electrode side solid electrolyte layer transfer step S7, a negative electrode sheet member lamination step S8, and an integration press step S9.

The positive electrode sheet member feeding step S1 is a step of conveying and feeding the positive electrode sheet member 200 by a conveying roller (not shown). That is, the positive electrode sheet member 200 where the positive electrode active material is coated and laminated on the positive electrode current collecting foil 42a constituting the positive electrode current collector layer 42 is fed.

The first solid electrolyte layer transfer step S2 is a step of transferring the first solid electrolyte layer SE1 to the positive electrode sheet member 200 by the first positive electrode transfer roller 120. Specifically, in the first solid electrolyte layer transfer step S2, the first solid electrolyte layer SE1 is positioned to be disposed within a range guided by a guide roller (not shown). Then, a slurry constituting the first solid electrolyte layer SE1 is passed on the positive electrode sheet member 200 while being pressed by a pair of first positive electrode transfer rollers 120 to perform transfer pressing. A pressure at this time is, for example, 50 MPa to 500 MPa at ambient temperature (for example, 10°C to 35°C). The pressure is preferably 100 MPa at 25°C.

The base material sheet peeling step S3 is a step of peeling, by the peeling roller 130, the base material sheet 123 from the first solid electrolyte layer SE1 subjected to the transfer pressing. Specifically, the base material sheet peeling step S3 includes a recognition step S30, a peeling start point control step S31, and a peeling step S32.

The recognition step S30 is a step of recognizing the peeling start point P at which the base material sheet 123 is peeled. That is, as described above, the peeling start point P is constantly monitored by the recognizer 300 that recognizes the peeling start point P. Information on the peeling start point P recognized by the recognizer 300 is output to the controller 400.

The peeling start point control step S31 is a step of performing control such that the peeling start point P is placed at the predetermined position. As described above, the predetermined position is an ideal position for the peeling start point P, and the controller 400 performs feedback control on the rotation speed of the base material roll body 131 such that the peeling start point P recognized by the recognizer 300 is placed at the predetermined position. Since the specific control contents are as described above, the description thereof will be omitted here.

The peeling step S32 is a step of peeling the base material sheet 123 in the direction opposite to the conveyance direction of the positive electrode sheet member 200 based on the peeling start point P controlled to the predetermined position. That is, by controlling the rotation speed of the base material roll body 131 by the controller 400, the peeling start point P is controlled to be placed at the predetermined position, and the base material sheet 123 is peeled in the direction opposite to the conveyance direction by the peeling roller 130 disposed upstream of the peeling start point P, with reference to the position.

The positive electrode press step S4 is a step of pressing (stamping), by the positive electrode press roll 180, the positive electrode sheet member 200 to which the first solid electrolyte layer SE1 is transferred. The positive electrode is densified by the positive electrode press step S4. A pressing (stamping) pressure for densifying is, for example, about 800 MPa to 1200 MPa at 25°C to 100°C. A densified laminate of the positive electrode sheet member 200 and the first solid electrolyte layer SE1 is conveyed downstream in the conveyance line.

The second solid electrolyte layer transfer step S5 is a step of transferring, by the second positive electrode transfer roller 140, the second solid electrolyte layer SE2 onto the positive electrode sheet member 200 to which the first solid electrolyte layer SE1 is transferred and pressed after the positive electrode press step S4. Specifically, in the second solid electrolyte layer transfer step S5, the second solid electrolyte layer SE2 is positioned to be disposed within a range guided by a guide roller (not shown) on the positive electrode sheet member 200 to which the first solid electrolyte layer SE1 is transferred. Then, a slurry constituting the second solid electrolyte layer SE2 is passed on the positive electrode sheet member 200 while being pressed by the second positive electrode transfer roller 140 as a transfer roller to perform transfer pressing. A pressure at this time is, for example, 50 MPa to 500 MPa at ambient temperature (for example, 10°C to 35°C). In this way, the positive electrode sheet member 200 is pressed twice or more. The pressure is preferably 150 MPa at 25°C.

Meanwhile, the negative electrode sheet member 210 is prepared at a position away from the conveyance line. First, as shown on an upper side in FIG. 5, the intermediate layer 5 is transferred, by the intermediate layer transfer roller 150, to the negative electrode active material layer 21 laminated on the negative electrode current collecting foil 22a (intermediate layer transfer step S6). Then, as shown on a lower side in FIG. 5, the negative electrode sheet member 210 is formed by transferring the negative electrode side solid electrolyte layer SE3 onto the intermediate layer 5 by the negative electrode transfer roller 160 (negative electrode side solid electrolyte layer transfer step S7). Accordingly, the intermediate layer 5 is disposed between the negative electrode active material layer 21 and the negative electrode side solid electrolyte layer SE3. In the embodiment, the negative electrode sheet member 210 includes a laminate of the negative electrode current collecting foil 22a, the negative electrode active material layer 21, the intermediate layer 5, and the negative electrode side solid electrolyte layer SE3, and alternatively, the negative electrode active material layer 21 and the intermediate layer 5 may not be contained.

In the intermediate layer transfer step S6, a slurry constituting the intermediate layer 5 is positioned to be disposed within a range guided by a guide roller (not shown) on the negative electrode active material layer 21. Then, the intermediate layer 5 is pressed and passed on the negative electrode active material layer 21 by the intermediate layer transfer roller 150 as a transfer roller to perform intermediate layer transfer pressing for transferring the intermediate layer 5 to the negative electrode active material layer 21. A pressure at this time is, for example, 50 MPa to 800 MPa at ambient temperature (for example, 10°C to 35°C). More preferably, the pressure is in a range of 300 MPa or more and 800 MPa or less at 25°C.

In the negative electrode side solid electrolyte layer transfer step S7, a slurry constituting the negative electrode side solid electrolyte layer SE3 is positioned to be disposed within a range guided by a guide roller (not shown) on the intermediate layer 5. Then, the negative electrode side solid electrolyte layer SE3 is pressed and passed on the intermediate layer 5 by the negative electrode transfer roller 160 as a transfer roller, and negative electrode active material layer transfer pressing for transferring the negative electrode side solid electrolyte layer SE3 to the intermediate layer 5 is performed. A pressure at this time is, for example, 600 MPa to 800 MPa at ambient temperature (for example, 10°C to 35°C).

Regarding the pressure, the pressing (stamping) pressure in the positive electrode press step S4 is not only a maximum press value for pressing the positive electrode sheet member 200 but also a maximum press pressure value in the entire method of the press device. The positive electrode sheet member 200 is pressed (stamped) at a high pressure in order to increase energy density and densify the electrode. The maximum pressure value in the positive electrode press step S4 is equal to or greater than a maximum pressure value for pressing (stamping) the negative electrode sheet member 210.

The pressure at the time of transfer in the first solid electrolyte layer transfer step S2 and the second solid electrolyte layer transfer step S5 is also smaller than the pressure in the positive electrode press step S4. The pressure at the time of transfer in the first solid electrolyte layer transfer step S2 and the second solid electrolyte layer transfer step S5 is also smaller than the pressure in the negative electrode side solid electrolyte layer transfer step S7.

Since the first solid electrolyte layer SE1 and the second solid electrolyte layer SE2 contain a relatively large amount of binder, the pressure during transfer can be reduced. In addition, by setting the pressure for transfer as low as possible, elongation of the first solid electrolyte layer SE1 and the second solid electrolyte layer SE2 due to transfer pressing can be reduced. Therefore, it is possible to leave room for the first solid electrolyte layer SE1 and the second solid electrolyte layer SE2 to extend in the subsequent integration press step S9 and the like, and the first solid electrolyte layer SE1 can be extended to follow the positive electrode layer 4. Thereby, adhesion between the first solid electrolyte layer SE1 and the positive electrode active material layer 41 can be improved.

After the negative electrode side solid electrolyte layer transfer step S7, the formed negative electrode sheet member 210 is cut by a cutter in a state of being supported by a payout roll that feeds the member transferred in the negative electrode side solid electrolyte layer transfer step S7. The negative electrode sheet member 210 is cut to a design dimension of the negative electrode layer 2 of the solid-state battery 1.

As shown in FIGS. 2 and 6, the negative electrode sheet member 210 cut to the design dimension is conveyed to the positive electrode sheet member 200 to join the conveyance line of the positive electrode sheet member 200, and is laminated on the positive electrode sheet member 200. At this time, before the integration press step S9 to be described later, on a surface of the positive electrode sheet member 200 facing the negative electrode side solid electrolyte layer SE3, the first solid electrolyte layer SE1 is provided on a lower layer side, and the second solid electrolyte layer SE2 is provided thereon. Then, the negative electrode sheet member 210 is disposed on the positive electrode sheet member 200 in a cut state.

Specifically, in the negative electrode sheet member lamination step S8, the negative electrode sheet member 210 to which the negative electrode side solid electrolyte layer SE3 is transferred is conveyed and laminated, by the negative electrode sheet member lamination roller 170, onto the positive electrode sheet member 200 to which the first solid electrolyte layer SE1 and the second solid electrolyte layer SE2 are transferred. In the negative electrode sheet member lamination step S8, the negative electrode sheet member 210 cut to the design dimension is positioned on the positive electrode sheet member 200, to which the first solid electrolyte layer SE1 and the second solid electrolyte layer SE2 are transferred, so as to be disposed within a range guided by a guide roller (not shown).

In this way, in a state where the positive electrode sheet member 200 and the negative electrode sheet member 210 are laminated, the electrode 10 is pressed (stamped) by the integration press roll 190 so as to be integrated (integration press step S9). In a state immediately before the integration press step S9, regarding thicknesses of the negative electrode sheet member 210 and the positive electrode sheet member 200 in the lamination direction, the thickness of the positive electrode sheet member 200 is greater than the thickness of the negative electrode sheet member 210. A pressure at this time is, for example, about 500 MPa to 900 MPa at 25°C to 100°C. Through the integration press step S9, the positive electrode sheet member 200 and the negative electrode sheet member 210 are integrated, and at the same time, the first solid electrolyte layer SE1, the second solid electrolyte layer SE2, and the negative electrode side solid electrolyte layer SE3 are densified. When the pressures in the integration press step S9 and the positive electrode press step S4 are compared, the pressure in the positive electrode press step S4 is higher than the pressure in the integration press step S9.

After the integration press step S9, the formed electrode 10 is cut by a rotary cutter.

The processes of transferring the first solid electrolyte layer SE1 in the first solid electrolyte layer transfer step S2, pressing the positive electrode sheet member 200 in the positive electrode press step S4, transferring the second solid electrolyte layer SE2 in the second solid electrolyte layer transfer step S5, laminating the negative electrode sheet member 210 before integration in the negative electrode sheet member lamination step S8, and the integration pressing in the integration press step S9 are performed on both surfaces of the positive electrode sheet member 200 fed in the positive electrode sheet member feeding step S1. Accordingly, as shown in FIG. 1, the solid-state battery 1 where the layers are symmetrically laminated on both upper and lower surfaces with the positive electrode sheet member 200 interposed therebetween is obtained.

In this way, in the embodiment, by peeling the base material sheet 123 in the direction opposite to the conveyance direction of the positive electrode sheet member 200, the base material sheet 123 is pulled in the direction against the conveyance direction, thus, for example, as compared to a case where the conveyance direction and the peeling direction are the same direction, it is possible to generate an appropriate shear force between the first solid electrolyte layer SE1 and the base material sheet 123, and it is possible to prevent occurrence of bending of the positive electrode sheet member 200 or occurrence of breakage of the positive electrode sheet member 200 starting from such a bend as a start point. As a result, it is possible to improve the peelability when the base material sheet 123 is peeled from the first solid electrolyte layer SE1.

Although the embodiment has been described above with reference to the drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the components in the above embodiment may be freely combined without departing from the gist of the invention.

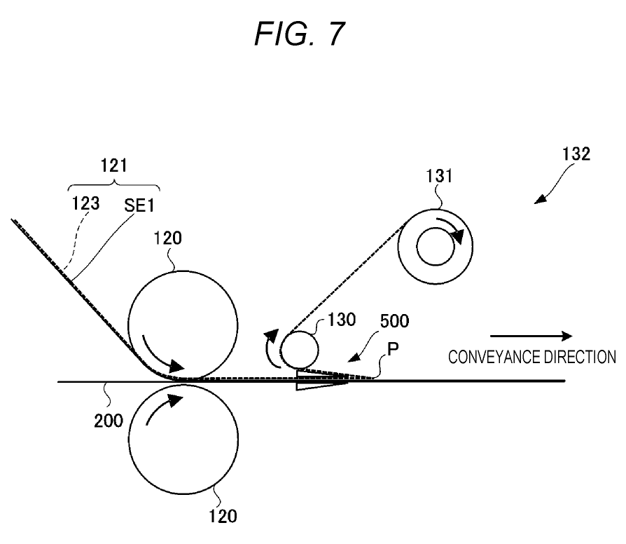

For example, in the above-described embodiment, as an example of peeling the base material sheet 123 in the direction opposite to the conveyance direction of the positive electrode sheet member 200, the peeling start point P is controlled to the predetermined position by feedback control using the recognizer 300 and the controller 400 to peel the base material sheet 123, and alternatively, another configuration may be adopted as long as the base material sheet 123 is peeled in the direction opposite to the conveyance direction. For example, as shown in FIG. 7, a guide mechanism 500 for peeling the base material sheet 123 in the direction opposite to the conveyance direction with the peeling start point P serving as a start point may be provided. In the case of such a configuration, for example, it is possible to peel the base material sheet 123 in the direction opposite to the conveyance direction without providing configurations such as the recognizer 300 described above.

In the above-described embodiment, various solid electrolyte layers are laminated on both surfaces of the positive electrode sheet member 200, and alternatively, the lamination may be performed on only one surface.

In the present specification, at least the following matters are described. Although corresponding components in the embodiment described above are shown in parentheses, the present invention is not limited thereto.

(1) A peeling mechanism (peeling mechanism 132) configured to peel a base material (base material sheet 123) from a transfer body (first solid electrolyte layer SE1) transferred to a substrate sheet (positive electrode sheet member 200), the peeling mechanism including:

a peeling roller (peeling roller 130) configured to peel the base material from the transfer body; and

a base material roll body (base material roll body 131) configured to wind the base material peeled by the peeling roller, in which

the peeling roller peels the base material in a direction opposite to a conveyance direction of the substrate sheet.

According to (1), since the base material is pulled in a direction against the conveyance direction of the substrate sheet by peeling the base material in the direction opposite to the conveyance direction of the substrate sheet, it is possible to appropriately generate a shear force between the substrate sheet and the transfer body, for example, as compared to a case where the base material is peeled in the same direction as the conveyance direction. As a result, it is possible to prevent occurrence of bending of the substrate sheet and occurrence of breakage starting from such a bend as a start point. That is, peelability of the base material when the base material is peeled from the transfer body can be improved.

(2) The peeling mechanism according to (1), in which the peeling roller is disposed upstream in the conveyance direction with respect to a peeling start point (peeling start point P) at which the base material is peeled.

According to (2), since the peeling roller is placed upstream in the conveyance direction with respect to the peeling start point at which the base material is peeled, the base material can be reliably pulled in the direction opposite to the conveyance direction, and thus an appropriate shear force can be generated between the substrate sheet and the transfer body.

(3) The peeling mechanism according to (2), further including:

a recognizer (recognizer 300) configured to recognize the peeling start point; and

a controller (controller 400) configured to control a rotation speed of the base material roll body, in which

the controller controls the rotation speed of the base material roll body such that the peeling start point recognized by the recognizer is placed at a predetermined position.

According to (3), the base material can be stably peeled by performing feedback control based on recognition by the recognizer such that the peeling start point is placed at the predetermined position.

(4) The peeling mechanism according to (3), in which the controller increases the rotation speed of the base material roll body in a case where the peeling start point is placed downstream of the predetermined position, and reduces the rotation speed of the base material roll body in a case where the peeling start point is placed upstream of the predetermined position.

According to (4), a speed of winding the base material by the base material roll body may not match a speed of conveying the substrate sheet, and in this case, the peeling start point is displaced from the predetermined position, but the peeling start point can be controlled to the predetermined position by controlling the rotation speed of the base material roll body according to the displacement from the predetermined position. Accordingly, the base material can be stably peeled.

(5) The peeling mechanism according to (2), in which

a peeling start point line connecting the peeling start points is inclined with respect to a width direction orthogonal to the conveyance direction on the substrate sheet to which the transfer body is transferred.

According to (5), the base material can be peeled along the peeling start point line inclined in the width direction, for example, occurrence of stress concentration at the predetermined peeling start point can be prevented, and as a result, the peelability of the base material can be improved.

(6) The peeling mechanism according to (5), in which

one side of the peeling roller in the width direction is inclined with respect to an other side of the peeling roller.

According to (6), since the one side of the peeling roller is inclined with respect to the other side in the width direction, the base material can be peeled along the peeling start point line.

(7) The peeling mechanism according to (1) or (2), in which

the transfer body is a solid electrolyte layer (first solid electrolyte layer SE1), and

the substrate sheet is a positive electrode sheet member (positive electrode sheet member 200).

According to (7), the base material can be appropriately peeled from the solid electrolyte layer transferred to the positive electrode sheet member.

(8) A peeling method of peeling a base material (base material sheet 123) from a transfer body (first solid electrolyte layer SE1) transferred to a substrate sheet (positive electrode sheet member 200), the peeling method including:

a recognition step (recognition step S30) of recognizing a peeling start point (peeling start point P) at which the base material is peeled;

a peeling start point control step (peeling start point control step S31) of controlling the peeling start point to be placed at a predetermined position; and

a peeling step (peeling step S32) of peeling the base material in a direction opposite to a conveyance direction of the substrate sheet, based on the peeling start point controlled to the predetermined position.

According to (8), the peeling start point is controlled to the predetermined position, the base material is peeled in the direction opposite to the conveyance direction with the controlled position serving as a start point, and thus the base material can be stably peeled. Accordingly, bending of the substrate sheet and breakage of the substrate sheet can be prevented, and peelability of the base material can be improved.

What is claimed is:

1. A peeling mechanism configured to peel a base material from a transfer body transferred to a substrate sheet, the peeling mechanism comprising:
a peeling roller configured to peel the base material from the transfer body; and
a base material roll body configured to wind the base material peeled by the peeling roller, wherein
the peeling roller peels the base material in a direction opposite to a conveyance direction of the substrate sheet.

2. The peeling mechanism according to claim 1, wherein
the peeling roller is disposed upstream in the conveyance direction with respect to a peeling start point at which the base material is peeled.

3. The peeling mechanism according to claim 2, further comprising:
a recognizer configured to recognize the peeling start point; and
a controller configured to control a rotation speed of the base material roll body, wherein
the controller controls the rotation speed of the base material roll body such that the peeling start point recognized by the recognizer is placed at a predetermined position.

4. The peeling mechanism according to claim 3, wherein
the controller
increases the rotation speed of the base material roll body in a case where the peeling start point is placed downstream of the predetermined position, and
reduces the rotation speed of the base material roll body in a case where the peeling start point is placed upstream of the predetermined position.

5. The peeling mechanism according to claim 2, wherein
a peeling start point line connecting the peeling start points is inclined with respect to a width direction orthogonal to the conveyance direction on the substrate sheet to which the transfer body is transferred.

6. The peeling mechanism according to claim 5, wherein
one side of the peeling roller in the width direction is inclined with respect to an other side of the peeling roller.

7. The peeling mechanism according to claim 1, wherein
the transfer body is a solid electrolyte layer, and
the substrate sheet is a positive electrode sheet member.

8. A peeling method of peeling a base material from a transfer body transferred to a substrate sheet, the peeling method comprising:
recognizing a peeling start point at which the base material is peeled;
controlling the peeling start point to be placed at a predetermined position; and
peeling the base material in a direction opposite to a conveyance direction of the substrate sheet, based on the peeling start point controlled to the predetermined position.
